(19) United States
(12) Patent Application Publication
(10) Pub. No.: US 2023/0212720 A1
(43) Pub. Date: Jul. 6, 2023

(54) METHOD FOR THE PRODUCTION OF HIGH PERMEABILITY GRAIN ORIENTED ELECTRICAL STEEL CONTAINING CHROMIUM

(71) Applicant: Cleveland-Cliffs Steel Properties Inc., West Chester, OH (US)

(72) Inventor: Jerry W. Schoen, Cincinnati, OH (US)

(21) Appl. No.: 17/566,044

(22) Filed: Dec. 30, 2021

(51) Int. Cl. C22C 38/34; C21D 8/12; C21D 6/00; C22C 38/20; C22C 38/04; C22C 38/00

(52) U.S. Cl. CPC C22C 38/34; C21D 8/1255; C21D 8/1233; C21D 8/1283; C21D 6/008; C22C 38/20; C22C 38/04; C22C 38/002; C21D 2211/001

(57) ABSTRACT

A high permeability grain oriented electrical steel having a chemistry comprising, all in weight percent, 2.5% to 4.5% silicon, 0.02% to 0.08% carbon, 0.01 to 0.05% aluminum, 0.005% to 0.050% sulfur or selenium, 0.02 to 0.20% manganese, 0.05 to 0.20% tin, 0.05 to 1% copper, 0.5% to 2.0% chromium, up to 0.10% phosphorus and up to 0.20% antimony with the balance being essentially iron and residual elements. The steel contains chromium and phosphorus in such amounts that a Cr:(P+0.25Sb) ratio is below 80:1 or, below 50:1, or below 30:1 which provides highly stable magnetic properties in the finished steel sheet. A hot processed band comprised of such steel is annealed and rapidly cooled after such annealing at a rate of at least 50° C. per second from 875-950° C. to a temperature below 400° C. prior to cold rolling to final thickness. Such steel forming a hot processed band having a thickness of from 1.5 to 4.0 mm and having a volume resistivity of at least 50 μΩ-cm, an austenite volume fraction (γ1150° C.) of at least 20%, and an isomorphic layer thickness of at least 2% of the total thickness on at least one surface of the hot processed band.

### BACKGROUND

Electrical steels are broadly characterized into two types. Non-oriented electrical steels are engineered to provide uniform magnetic properties in all directions. Grain oriented electrical steels are engineered to provide high volume resistivity with highly directional magnetic properties due to the development of a preferential grain orientation.

Electrical steels are comprised of iron that is alloyed with silicon, aluminum and other elements to impart high volume resistivity to the steel sheet and reduced core loss during AC magnetization. Non-oriented electrical steels typically include silicon, manganese, aluminum and other elements commonly known in the art to provide high volume resistivity and low core losses. Grain oriented electrical steels typically include silicon with small amounts of manganese, aluminum and other elements added for other purposes such as the provision of primary grain growth inhibition important to grain oriented electrical steels or the provision of specific metallurgical features important to the process of producing the steels. Equation (1) can be used to calculate the effect of common alloying additions in electrical steels on the volume resistivity (ρ) of the steel which is commonly reported in microohm-centimeter (μΩ-cm).

ρ (μΩ-cm)=9+11.25(% Si)+11.52(% Al)+6.78(% Cr)+6.25(% Mn)+2.5(% Cu)+2.5(% Ni)+3.75(% Mo)+14(% P)+5.34(% Sn) (1)

where % Si, % Al, % Cr, % Mn, % Cu, % Ni, % Mo, % P and % Sn are the weight percentages of silicon, manganese, aluminum, chromium, copper, nickel, molybdenum, phosphorus and tin, respectively, contained in the steel.

Grain oriented electrical steels are differentiated by the type(s) of grain growth inhibition employed, method of processing, quality of the (110)[001] grain orientation achieved, and the core loss of the finished steel. Grain oriented electrical steels are typically separated into two subclasses indicated by magnetic permeability measured at 796 A/m or 800 A/m. Regular (or conventional) grain oriented electrical steels have a magnetic permeability of at least 1780 and high permeability grain oriented electrical steels have a magnetic permeability of at least about 1840 and typically greater than 1880.

To achieve the desired magnetic properties in a grain oriented electrical steel, the (110)[001] or “Goss” grain orientation is developed during the final high temperature anneal of the steel by a process commonly referred to in the art as secondary grain growth. Secondary grain growth is a process by which small cube-on-edge oriented grains preferentially grow to consume grains of other orientations. Vigorous secondary grain growth is primarily dependent on two factors.

First, a grain growth inhibitor dispersion capable of restraining primary grain growth appropriate for secondary grain growth must be provided. The typical methods employed in the production of higher permeability grain oriented electrical steels rely on aluminum nitride precipitates or aluminum nitride precipitates in combination with manganese or copper sulfide precipitates, manganese selenides or other nitrides such as boron, silicon and other elements.

Second, the grain structure and crystalline texture of the steel, particularly the surface and near-surface layers of the steel surface, must provide conditions appropriate for secondary grain growth. The characteristics of the surface and near-surface layers of the steel surface in the hot processed band are important to the development of a high permeability grain oriented electrical steel. This surface region, depleted of carbon and substantially free of austenite and its decomposition products, provides a substantially single phase, or isomorphic, ferritic microstructure which is referred to in the art as the surface decarburized layer. In contrast, the microstructure of the interior of the hot processed band is polymorphic comprising mixed phases of ferrite, austenite, or austenite decomposition products. The boundary between these surface and interior layers is commonly referred to in the art as the shear band. The proper thickness, microstructure, and composition of the shear band aid in the development of the Goss orientation because the nuclei grains with the highest likelihood of producing vigorous secondary grain growth with a high degree of cube-on-edge grain orientation are found within the isomorphic layer and near the boundary between the surface isomorphic and interior polymorphic layers.

The amounts of ferrite and austenite are also important for production of high permeability grain oriented electrical steels. Such steels typically contain at least 20% austenite, or in some cases typically 25 to 55% austenite, or in other cases 35 to 45% austenite. During process annealing, the austenite enhances aluminum nitride dissolution and precipitation and, upon cooling, transforms into hard second phases such as martensite, bainite, retained austenite and like phases. The formation of such hard phases is important for the development of the near <111> fiber texture after the cold rolled strip undergoes recrystallization annealing, such as during decarburization annealing, and the development of cube-on-edge nuclei at the boundary between the isomorphic and polymorphic layers. Equation (2) below is an equation to calculate the peak austenite volume fraction at 1150° C. (γ1150° C.) in steel containing about 3.0-3.6% silicon, 0.02-0.08% carbon and up to 2.0% chromium.

γ1150° C.=162+960(% C)+43(% Mn)−177(% P)−61(% S)−60(% Si)+13(% Cr)+32(% Ni)−23(% Mo)+29(% Cu)−110(% Al)+200(% N) (2)

Using this equation, γ1150° C. is calculated using the weight percentages of carbon, manganese, phosphorus, sulfur, silicon, chromium, nickel, molybdenum, copper, aluminum and nitrogen, respectively, contained in the steel.

Prior art grain oriented electrical steels typically contained silicon levels of 2.95% to 3.45% silicon that would provide a volume resistivity of about 45-50 μΩ-cm using Equation (1). These higher levels of silicon have been long known to cause physical manufacturing problems owing to reduced ductility, increased brittleness, and increased sensitivity to processing temperatures, all of which affect the difficulty and cost of manufacture. The use of such higher silicon levels also typically requires higher levels of austenite-forming elements to maintain the proper proportions, or phase balance, of austenite and ferrite in the steel. Carbon is the most common addition to increase the level of austenite. The use of higher levels of silicon and carbon typically results in lowering the solidus temperature which has an important influence on the formation of defects that can occur during high temperature processing such as solidification, slab or strip casting, slab or strip reheating and/or hot rolling. In addition, higher levels of silicon and carbon also can have deleterious effects on physical ductility and brittleness, increasing the difficulty of cold rolling, and increasing the time required for carbon removal during decarburization annealing. As a result, the technical difficulties and manufacturing costs of processing of the steel increase.

Chromium additions are employed to provide higher volume resistivity, enhance the formation of austenite, and provide other beneficial characteristics in the manufacture of the grain oriented electrical steel. The use of chromium additions for the production of grain oriented electrical steels is taught in U.S. Pat. No. 5,421,911, entitled “Regular Grain Oriented Electrical Steel Production Process,” issued Jun. 6, 1995; U.S. Pat. No. 5,702,539, entitled “Method for Producing Silicon-Chromium Grain Oriented Electrical Steel,” issued Dec. 30, 1997; and U.S. Pat. No. 7,887,645, entitled “High Permeability Grain Oriented Electrical Steel,” issued Feb. 15, 2011; and U.S. Pat. No. 9,881,720, entitled “Grain Oriented Electrical Steel with Improved Forsterite Coating Characteristics.” The teachings of each of these three patents are incorporated herein by reference.

In commercial practice, additions of from 0.10% to 0.40% chromium have been employed, with typical additions being from 0.20% to 0.35%. Steels having a chromium content of 0.30-0.35% are known to consistently produce both good physical processing characteristics and magnetic properties provided that the conditions for composition, austenite-ferrite phase balance, isomorphic layer thickness, and cooling after annealing prior to final cold rolling are satisfied. The amount of the austenite formed during the annealing step and transformation of the austenite to form a “hard phase”, that is, martensite, retained austenite, bainite and/or like phases, during cooling after the annealing step and prior to cold rolling to final thickness must be controlled. However, at levels above 0.50% chromium, and more particularly above 0.75% chromium, control of austenite transformation can become increasingly difficult. As the chromium content increases, austenite transformation into the desired “hard phases” after the annealing and rapid cooling process diminishes and phases such ferrite, cementite, pearlite (a ferrite-cementite aggregate) or mixtures thereof form that, in turn, can result in increasingly poor and erratic development of the (110)[001] grain orientation needed for superior magnetic properties in the finished steel. As a result, industrial practice has been limited to a maximum chromium content of about 0.40%.

### SUMMARY

A high permeability grain oriented electrical steel containing up to 2% chromium having excellent mechanical and magnetic properties is produced using grain growth inhibitors primarily comprised of aluminum nitride used singly or in combination with one or more of manganese sulfide, manganese selenide or other inhibitors. A hot processed band having a thickness of 1.5 to 4.0 mm has a chemistry comprising, all in weight percentages, 2.5% to 4.5% silicon, 0.02% to 0.08% carbon, 0.01% to 0.05% aluminum, 0.005% to 0.050% sulfur or selenium, 0.02% to 0.20% manganese, 0.05% to 0.20% tin, 0.05% to 1% copper, 0.5% to 2.0% chromium, up to 0.10% phosphorus and up to 0.20% antimony with the balance being essentially iron and residual elements incidental to the method of steelmaking. In the present application, the term “band” is generally used to identify a steel product after it has been hot rolled but prior to annealing before cold rolling, and the term “strip” is generally used to identify the steel product after such annealing. The steel contains chromium and phosphorus/antimony in such amounts that a Cr:[P+(0.25Sb)] ratio of below 80:1, below 50:1, or below 30:1 is provided to ensure stable magnetic properties and better manufacturability in the finished steel sheet. In certain embodiments, such a steel is rapidly cooled after annealing of the hot rolled steel at a rate in excess of 50° C. per second, or in excess of 60° C. per second, or in excess of 70° C. per second.

The present high permeability grain oriented electrical steels have a volume resistivity of at least 50 μΩ-cm, and the hot processed band has an austenite fraction (γ1150° C.) of at least 20% and an isomorphic layer thickness of at least 2% of the total thickness on at least one surface of the hot processed band, said band having a thickness of 1.5 to 4.0 mm.

### DESCRIPTION OF FIGURES

FIG. 1 provides photographs of microstructures obtained after annealing and rapid cooling from 940° F. to 340° F. at 60° C. per second.

FIG. 2 provides a chart showing permeability at 796 A/m vs. Cr:[P+(0.25Sb)] ratio for the steels of Ex. 3.

FIG. 3 provides a chart showing core loss at 1.7T 60 Hz vs. Cr:[P+(0.25Sb)] ratio for the steels of Ex. 3.

FIG. 4 provides a chart showing permeability at 796 A/m vs. Cr:[P+(0.25Sb)] ratio for the steels of Ex. 4.

FIG. 5 provides a chart showing core loss at 1.7T 60 Hz vs. Cr:[P+(0.25Sb)] ratio for the steels of Ex. 4.

### DETAILED DESCRIPTION

The present high permeability grain oriented electrical steels reduce the deleterious effect of chromium on the efficient transformation of austenite into hard second phases, while permitting addition of chromium at higher levels to obtain its positive effects. Thus, the steel has a magnetic permeability measured at 796 A/m of at least 1840. The present steel comprises 2.5% to 4.5% silicon, 0.5% to 2.0% chromium, 0.02% to 0.08% carbon, 0.01% to 0.05% aluminum, 0.005% to 0.012% nitrogen, 0.005% to 0.050% sulfur or selenium, 0.02% to 0.20% manganese, 0.05% to 0.20% tin, 0.05% to 1% copper, up to 0.10% phosphorus, and up to 0.20% antimony, with the balance being essentially iron and residual elements incidental to the method of steelmaking.

Silicon is added to the melt primarily to improve the core loss by providing higher volume resistivity. In addition, silicon promotes the formation and/or stabilization of ferrite and, as such, is one of the major elements affecting the volume fraction (γ1150° C.) of austenite. While higher silicon is desired to improve the magnetic quality, its effect must be considered to maintain the desired phase balance, microstructural characteristics and mechanical properties. In the present steels, silicon is present in amounts by percentage of weight of 2.5% to 4.5%, or some cases in amounts of 2.75% to 3.75%, or in other cases in amounts of 2.90% to 3.50%.

Chromium is added to the melt primarily to improve the core loss by providing higher volume resistivity which is conducive to lowering core loss of the present steels. However, chromium has other effects on the austenite-ferrite phase balance and formation of some desired characteristics that must be considered. While chromium promotes the formation of austenite, higher amounts of chromium will affect austenite decomposition during cooling in the present steels. In the present steels, chromium is present in amounts by weight of 0.5% to 2.0%, or some cases in amounts of 0.6% to 1.8%, or in other cases in amounts of 0.7% to 1.7%. Steels containing above 2.0% chromium demonstrated problems in decarburization annealing wherein achieving a final level of less than 0.003% carbon to prevent magnetic aging became increasingly difficult.

Carbon is added to the melt primarily to promote the formation and/or stabilization of austenite and, as such, is one of the elements affecting the volume fraction (γ1150° C.) of austenite. A carbon concentration of less than 0.02% immediately prior to the cold reduction to the intermediate thickness is undesirable because secondary recrystallization becomes unstable and the quality of the cube-on-edge orientation of the product is impaired. High percentages of carbon above 0.08% are undesirable because thinning of the isomorphic layer thickness may occur which weakens secondary grain growth, results in a poorer cube-on-edge orientation and increases the difficulty of decarburization of the strip to a level of less than 0.003% carbon needed to prevent magnetic aging. In the present steels, carbon is present in the melt and hot band in amounts by weight of 0.02% to 0.08%, or in some cases in amounts of 0.03% to 0.07%, or in other cases in amounts of 0.04% to 0.06%.

Aluminum is added in the melt to combine with nitrogen to form the aluminum nitride precipitates needed for primary grain growth inhibition to aid stable and vigorous secondary grain growth. While aluminum is also helpful to control the amount of dissolved oxygen in the steel melt, the percentage of soluble aluminum must be maintained within upper and lower limits. In the present steels, soluble aluminum is present in amounts by weight of 0.01% to 0.05%, or in some cases in amounts of 0.015% to 0.040%, or in other cases in amounts of 0.020% to 0.035%.

Nitrogen is added in the melt to combine with aluminum to form the aluminum nitride precipitates needed for primary grain growth inhibition that aids stable and vigorous secondary grain growth. In the present steels, nitrogen is present in amounts by weight of 0.005% to 0.0120%, or in some cases in amounts of 0.008% to 0.011%, or in other cases in amounts of 0.009% to 0.010%. In other embodiments, the level of nitrogen in the strip can be augmented using strip nitriding prior to high temperature annealing. In the practice of this method, the combined levels of nitrogen provided in the melt and the nitrogen provided by nitriding range from 0.0120% to 0.030%.

Sulfur and selenium may be added in the melt to combine with manganese to form the manganese sulfide and/or manganese selenide precipitates needed for primary grain growth inhibition. In the present steels, sulfur is present in amounts by weight of 0.005% to 0.050%, or in some cases in amounts of 0.015% to 0.035%. Some or all the sulfur in the present steels can be replaced by selenium, such that the amount of sulfur plus selenium, or selenium alone, is present in amounts by weight of 0.005% to 0.050%, or in some cases in amounts of 0.015% to 0.035%.

Manganese is added in the melt to combine with sulfur to form the manganese sulfide and/or manganese selenide precipitates needed for primary grain growth inhibition. Using conventional methods of steel melting and casting wherein continuously cast slabs are used to produce a starting band for processing in accordance with the present method, a lower percentage of excess manganese, i.e., manganese uncombined as manganese sulfide or manganese selenide, is advantageous to ease dissolution of manganese sulfide during slab reheating prior to hot rolling. In the present steels, manganese is present in amounts by weight of 0.02% to 0.20%, or in some cases in amounts of 0.03% to 0.12%, or in other cases in amounts of 0.04% to 0.08%.

Tin is added in the melt to enhance the function of the aluminum nitride and other grain growth inhibitors. Tin in the present steels is present in amounts by weight of 0.03% to 0.25%, or in some cases in amounts of 0.05% to 0.20%, or in other cases in amounts of 0.10% to 0.15%. Tin levels below 0.03% are insufficient to enhance the quality of the grain growth inhibitor while levels above 0.25% can interfere with pickling prior to cold rolling and carbon removal during decarburization annealing.

Copper is added in the melt to enhance formation of the forsterite coating and enhance the core loss of the steel by reducing the size of the (110)[001] grains formed in the finished steel. In the present steel, copper is present in amounts by weight of 0.03% to 1.0%, or in some cases in amounts by weight of 0.05-0.45%, or in other cases in amounts by weight of 0.10% to 0.30%. Copper levels below 0.03% are insufficient to enhance the quality of the forsterite coating while levels above 1.0% can interfere with pickling prior to cold rolling and carbon removal during decarburization annealing.

Phosphorus is added in the melt primarily to enhance the processing of the present steels and, secondarily, phosphorus is helpful to increase the volume resistivity of the steel. Phosphorus additions are useful for controlling the austenite transformation process by promoting formation of technically useful “hard phases” and suppressing formation of cementite. In the present steels, phosphorus is present in amounts by weight of up to 0.10%, or in some cases in amounts by weight of 0.015-0.065%, or in other cases in amounts by weight of 0.020% to 0.045%. Phosphorus levels below 0.005% are insufficient for control of austenite decomposition while levels above 0.10% can degrade the mechanical qualities of the steel during cold rolling and slow carbon removal during decarburization annealing.

Antimony functions in a manner similar to phosphorus in affecting the austenite transformation process and formation of cementite. In the present steels, antimony is present in amounts by weight of up to 0.2%, or in some cases in amounts of 0.015% to 0.15%, or in other cases in amounts of 0% to 0.014%.

In the present steels, chromium and phosphorus and/or antimony, measured in weight percentages, are employed in amounts appropriate for control of the austenite transformation during cooling into “hard phases” such as martensite, retained austenite, bainite and like phases necessary to achieve a high quality (110)[001] grain orientation in the finished steel sheet. Thereby, in the present steel, a Cr:P ratio of below 80:1, or below 50:1, or below 30:1 must be provided. It is further believed that antimony functions in a similar manner either in place of or in addition to phosphorus and in which instance, the ratio is stated as Cr:[P+(0.25Sb)]. In the present steel, the amounts of chromium, phosphorus and antimony employed must provide a Cr[P+(0.25Sb)] ratio of below 80:1, or below 50:1, or below 30:1.

The balance of the steel comprises iron and residual elements incidental to the method of steelmaking.

The present high permeability grain oriented electrical steels can be produced by a number of methods. The band can be produced from ingots, slabs produced from ingots or continuous cast slabs which are reheated to 1100°−1400° C. followed by hot rolling to provide a starting hot processed band of 1.5-4.0 mm thickness. The present method is also applicable to a band produced by methods wherein continuous cast slabs or slabs produced from ingots are fed without significant heating, or the molten metal is cast directly into a band suitable for further processing. In some instances, equipment capabilities may be inadequate to provide starting hot processed band having an appropriate thickness for the present steels; however, a cold reduction of 30% or less or a hot reduction of up to 80% may be employed to provide an appropriate thickness prior to the annealing of the hot processed band.

The hot processed band is annealed at 1100° C.-1200° C. for a time sufficient for complete austenite formation. Carbon losses may occur during annealing that may require adjustment in the melt composition to maintain the desired austenite-ferrite phase balance. Moreover, such carbon loss may be affected by the amounts of silicon and chromium in the steel, the thickness of the starting strip, the oxidizing potential of the annealing atmosphere and/or the time and temperature of annealing. After annealing, the strip can be cooled at a rate of 10-20° C. per second to a temperature of 875-975° C. followed by rapid cooling to 400° C. or lower. The annealed strip is rapidly cooled at a rate in excess of 50° C. per second, or in same cases in excess of 60° C. per second, or in other cases at a rate in excess of 70° C. per second. Such rapid cooling is effective for control of the austenite transformation into the desired hard second phases for the present steels. The strip can then be air cooled from 400° C. to ambient temperature.

For high permeability grain oriented steels of the prior art, achieving the very rapid cooling needed to obtain a highly uniform microstructure across the entire strip width was difficult to achieve. Among other things, the use of very rapid cooling resulted in distortion of the strip flatness which accentuated temperature non-uniformities across the strip width and complicated further processing, particularly the step of cold rolling. Moreover, this produced a finished product with significant inconsistencies in magnetic properties, creating a barrier to the use of chromium levels at or above 0.50%. The present steels have been found to provide robust control of austenite transformation using rapid cooling. As a result, thermal distortion of the strip is reduced and a highly uniform microstructure of the annealed strip is produced. In addition, the finished product has excellent magnetic properties obtained using chromium levels above 0.50%.

The steel may be cold reduced in one or more stages separated by an annealing step such that the cold rolled strip prior to decarburization annealing is provided with a cold reduction of at least 80%. After the cold reduction to final thickness is completed, the steel is subjected to a decarburization annealing step to reduce the carbon to an amount which minimizes magnetic aging, typically less than 0.003% using a wet hydrogen-bearing atmosphere such as pure hydrogen or a mixture of hydrogen and nitrogen having a H₂O/H₂ ratio of nominally 0.35-0.55. The soak temperature for the decarburization annealing step is at least 800° C., or some cases at least 830° C. The decarburization annealing step for the present steel may be performed by rapidly heating the steel from a temperature of 450° C. or lower to a temperature of 740° C. or higher at a rate in excess of 500° C. per second. However, the decarburization annealing step does not require such a rapid heating rate. A strip nitriding treatment may optionally be provided during or after decarburization annealing. The decarburization anneal further prepares the steel for the formation of a forsterite, or “mill glass”, coating in a high temperature final anneal by reaction of the surface oxide skin and an annealing separator primarily comprised of magnesium oxide and optionally containing small amounts of titanium oxide, boron-bearing or chlorine-bearing additives.

The magnesia coated coil is then annealed at a high temperature of from 1100° C. to 1200° C. in a H₂—N₂ atmosphere for an extended time during which the (110)[001] grain orientation is developed, a forsterite or “mill glass” coating is formed on the surface of the steel and the steel is later purified by annealing in 100% H₂ as elements such as sulfur, selenium and nitrogen are substantially removed. This final high temperature anneal is needed to develop the cube-on-edge grain orientation. Typical annealing conditions employ heating rates of less than 80° C. per hour up to 815° C. and further heating at rates of less than 50° C. per hour to the completion of secondary grain growth. Once secondary grain growth is complete, the steel is held at soak temperature for a time of at least 5 hours, or in some cases at least 20 hours, to effect removal of the nitrogen, sulfur and/or selenium used as primary grain growth inhibitors and purify the finished steel.

After high temperature annealing is completed, the coil is cooled and unwound, cleaned to remove any residue from the magnesia separator coating and, typically, a C-5 insulation coating is applied over the forsterite coating and the steel is heat flattened. While it is common practice to apply some means of domain refinement to further lower the core loss of high permeability grain oriented electrical steel products, such additional processing is not necessary.

### Example 1

A series of industrial heats having melt compositions exemplary of the prior art and of the present high permeability grain oriented electrical steels are summarized in Table 1. Heats A through D have compositions representative of steels of the prior art method with phosphorus at a level of 0.010% or less which, at chromium contents above 0.50%, resulted in a Cr:[P+(0.25Sb)] ratio greater than 50:1 while Heats E through G were exemplary of the present high permeability grain oriented steels with a chromium content of 0.50% or above and with a phosphorus content sufficient to provide Cr:[P+(0.25Sb)] ratio which was at or below 45:1.

TABLE 1

| | | Summary of Melt Compositions | | | | | | | | | | | | | | | Volume |
|---|---|---|---|---|---|---|---|---|---|---|---|---|---|---|---|---|---|
| | | Chemistry in Weight Percent | | | | | | | | | | | | | Cr:(P + Sb/4) | | resistivity, |
| Method | Heat | C | Mn | P | S | Si | Cr | Ni | Mo | Cu | Sn | Ti | Al | N | ratio | γ_{1150° C.} | μΩ-cm |
| Prior Art | A | 0.055 | 0.075 | 0.009 | 0.026 | 2.94 | 0.35 | 0.10 | 0.02 | 0.18 | 0.12 | 0.002 | 0.032 | 0.009 | 38 | 47% | 47 |
| Prior Art | B | 0.054 | 0.078 | 0.005 | 0.025 | 3.14 | 0.33 | 0.10 | 0.03 | 0.15 | 0.07 | 0.002 | 0.030 | 0.007 | 66 | 34% | 49 |
| Prior Art | C | 0.050 | 0.068 | 0.009 | 0.025 | 3.04 | 0.67 | 0.09 | 0.02 | 0.16 | 0.12 | 0.002 | 0.034 | 0.009 | 74 | 40% | 50 |
| Prior Art | D | 0.055 | 0.074 | 0.008 | 0.026 | 3.08 | 0.89 | 0.09 | 0.02 | 0.15 | 0.11 | 0.002 | 0.032 | 0.010 | 111 | 46% | 52 |
| Example | E | 0.053 | 0.063 | 0.022 | 0.026 | 3.01 | 0.67 | 0.20 | 0.02 | 0.18 | 0.12 | 0.002 | 0.027 | 0.009 | 30 | 47% | 50 |
| Example | F | 0.047 | 0.061 | 0.033 | 0.025 | 3.01 | 0.90 | 0.20 | 0.02 | 0.18 | 0.12 | 0.002 | 0.029 | 0.010 | 27 | 42% | 52 |
| Example | G | 0.047 | 0.043 | 0.037 | 0.019 | 3.08 | 1.66 | 0.09 | 0.02 | 0.16 | 0.10 | 0.003 | 0.030 | 0.013 | 45 | 40% | 57 |

After melting, the steels were continuously cast into slabs having a thickness of 200 mm, heated to 1000-1100° C., provided with a reduction to a thickness of 150 mm, further heated to 1375-1400° C. and hot rolled so that the starting hot rolled band had a thickness of 2.0 mm. The hot rolled coils were processed in the plant wherein the coils were continuously strip annealed at a temperature of nominally 1150° C. for a time sufficient for complete austenite formation, air cooled at a rate of nominally 10-15° C. per second to a temperature of nominally 940° C. followed by rapid cooling at a rate of nominally 60° C. per second to 340° C. and finally cooled in ambient air to room temperature.

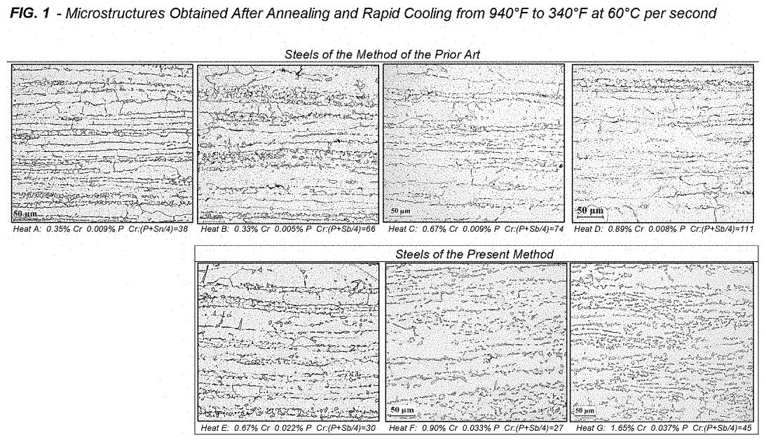

The microstructures were examined using optical metallography for phase identification after chemical etching, as shown in FIG. 1. Heats B, C and D show that as chromium content increased, the austenite transformation process resulted in increasing amounts of pearlite and/or ferrite with a reduced amount of the “hard phases”. In contrast, Heats E, F and G show that a consistent and efficient process of austenite decomposition was obtained resulting in the highly uniform formation of the desired “hard phases” in steels containing up to 1.66% chromium.

### Example 2

A series of heats were melted to chromium levels of from 0.65% to 1.51% as shown in Table 2. Heats H and I are compositions of the prior art method having a residual phosphorus level of 0.009%, providing a Cr:[P+(0.25Sb)] ratio at or above 73:1 while Heats J through N are compositions exemplary of the present high permeability grain oriented steels wherein a phosphorus addition was made to provide a Cr:[P+(0.25Sb)] ratio of 40:1 or below.

TABLE 2

| | | Summary of Melt Compositions | | | | | | | | | | | | | | | Volume |
|---|---|---|---|---|---|---|---|---|---|---|---|---|---|---|---|---|---|
| | | Chemistry in Weight Percent | | | | | | | | | | | | | Cr:(P + Sb/4) | | resistivity, |
| Method | Heat | C | Mn | P | S | Si | Cr | Ni | Mo | Cu | Sn | Ti | Al | N | ratio | γ_{1150° C.} | μΩ-cm |
| Prior Art | H | 0.053 | 0.068 | 0.009 | 0.026 | 3.05 | 0.65 | 0.10 | 0.02 | 0.18 | 0.12 | 0.002 | 0.029 | 0.009 | 73 | 43% | 50 |
| Prior Art | I | 0.045 | 0.063 | 0.009 | 0.023 | 3.05 | 0.89 | 0.09 | 0.02 | 0.15 | 0.12 | 0.002 | 0.035 | 0.010 | 99 | 38% | 52 |
| Example | J | 0.053 | 0.063 | 0.021 | 0.026 | 3.00 | 0.67 | 0.20 | 0.02 | 0.18 | 0.12 | 0.002 | 0.027 | 0.008 | 32 | 48% | 50 |
| Example | K | 0.047 | 0.061 | 0.033 | 0.025 | 3.01 | 0.90 | 0.20 | 0.02 | 0.18 | 0.12 | 0.002 | 0.029 | 0.010 | 27 | 42% | 52 |
| Example | L | 0.050 | 0.058 | 0.035 | 0.026 | 3.00 | 1.07 | 0.10 | 0.01 | 0.15 | 0.13 | 0.003 | 0.026 | 0.010 | 31 | 44% | 53 |
| Example | M | 0.048 | 0.059 | 0.038 | 0.025 | 3.03 | 1.07 | 0.09 | 0.01 | 0.15 | 0.13 | 0.003 | 0.026 | 0.010 | 28 | 39% | 53 |
| Example | N | 0.047 | 0.040 | 0.04 | 0.015 | 3.11 | 1.51 | 0.09 | 0.02 | 0.15 | 0.08 | 0.003 | 0.030 | 0.015 | 38 | 40% | 57 |

The steels were continuously cast into slabs and processed through hot rolling in a manner identical to the process of Example 1. Samples were taken from the hot rolled coils for laboratory study where the samples were annealed at a temperature of nominally 1150° C. for a time sufficient for complete austenite formation, air cooled at a rate of 10-15° C. per second to a temperature of 940° C. and then rapidly cooled at rates of 39, 50, 61, 67, 72, 78 and 83° C. per second to a temperature of 100° C. or less. The microstructure after annealing and rapid cooling was then examined by optical metallography after chemical etching for phase identification which results are summarized in Table 3.

TABLE 3
Summary of Microstructural Characteristics after Rapid Cooling

| | | | Cr:(P + | Cooling Rate from 940° C. | | | | | | |
|---|---|---|---|---|---|---|---|---|---|---|
| | | | Sb/4) | to <100° C., ° C. per second | | | | | | |
| Method | Heat | Cr | ratio | 39 | 50 | 61 | 67 | 72 | 78 | 83 |
| Prior art | H | 0.65 | 73 | [symbol] | [symbol] | [symbol] | [symbol] | [symbol] | [symbol] | [symbol] |
| Prior art | I | 0.89 | 99 | [symbol] | [symbol] | [symbol] | [symbol] | [symbol] | [symbol] | [symbol] |
| Example | J | 0.67 | 32 | [symbol] | [symbol] | [symbol] | [symbol] | [symbol] | [symbol] | [symbol] |
| Example | K | 0.90 | 27 | [symbol] | [symbol] | [symbol] | [symbol] | [symbol] | [symbol] | [symbol] |
| Example | L | 1.07 | 31 | [symbol] | [symbol] | [symbol] | [symbol] | [symbol] | [symbol] | [symbol] |
| Example | M | 1.07 | 28 | [symbol] | [symbol] | [symbol] | [symbol] | [symbol] | [symbol] | [symbol] |
| Example | N | 1.51 | 38 | [symbol] | [symbol] | [symbol] | [symbol] | [symbol] | [symbol] | [symbol] |

Poor [symbol] Pearlite, Little Hard Phase present [symbol]
Pearlite, some Hard Phase present [symbol]
Hard Phase, substantial Pearlite present
Acceptable [symbol] Hard Phase, some Pearlite present
Desired [symbol] Hard Phase, little or no Pearlite present

Heats H and I having chromium contents of 0.65% to 0.89% processed using rapid cooling at 30-50° C. per second produced poor microstructures; however, more nearly acceptable microstructures were obtained on Heat H upon cooling at a rate in excess of 72° C. per second and Heat I upon cooling at a rate in excess of 78° C. per second. However, the use of such intense cooling caused distortion of the strip flatness which then resulted in temperature non-uniformity during cooling that further resulted in microstructure non-uniformities and variable magnetic properties within the finished steel. In contrast, Heats J through N of the present high permeability grain oriented steels having a Cr:[P+(0.25Sb)] ratio of 40:1 or lower provided a consistently superior result across the range of cooling rates owing to improved control of the austenite transformation process such that highly consistent “hard phase” formation was obtained using only a moderately higher rate of cooling of 60° C. per second.

### Example 3

A series of industrial heats containing 0.64-0.68% chromium was melted having compositions exemplary of the prior art and the present high permeability grain oriented steels as shown in Table 4. Heats O, P and Q have compositions representative of a steel of the prior art having a phosphorus residual level of 0.008%-0.009%. Heats R through V having compositions exemplary of the present high permeability grain oriented steels contained up to 0.040% phosphorus with a Cr:[P+(0.25Sb)] ratio of below 50:1.

TABLE 4

| | | Melt Chemistry in Weight Percent | | | | | | | | | | | | |
|---|---|---|---|---|---|---|---|---|---|---|---|---|---|---|
| Method | Heat | C | Mn | P | S | Si | Cr | Ni | Mo | Cu | Sn | Ti | Al | N |
| Prior Art | O | 0.053 | 0.068 | 0.008 | 0.025 | 3.07 | 0.65 | 0.20 | 0.02 | 0.16 | 0.12 | 0.002 | 0.032 | 0.009 |
| Prior Art | P | 0.050 | 0.064 | 0.008 | 0.026 | 3.16 | 0.64 | 0.20 | 0.02 | 0.15 | 0.11 | 0.002 | 0.030 | 0.009 |
| Prior Art | Q | 0.052 | 0.066 | 0.009 | 0.024 | 3.04 | 0.65 | 0.20 | 0.02 | 0.16 | 0.12 | 0.002 | 0.033 | 0.010 |
| Example | R | 0.050 | 0.064 | 0.014 | 0.025 | 3.04 | 0.67 | 0.20 | 0.02 | 0.16 | 0.14 | 0.002 | 0.032 | 0.009 |
| Example | S | 0.051 | 0.064 | 0.014 | 0.026 | 3.04 | 0.67 | 0.20 | 0.02 | 0.16 | 0.14 | 0.002 | 0.031 | 0.009 |
| Example | T | 0.053 | 0.064 | 0.015 | 0.025 | 3.03 | 0.67 | 0.20 | 0.02 | 0.16 | 0.12 | 0.002 | 0.029 | 0.010 |
| Example | U | 0.055 | 0.063 | 0.022 | 0.024 | 3.07 | 0.67 | 0.20 | 0.02 | 0.15 | 0.12 | 0.002 | 0.032 | 0.010 |
| Example | V | 0.052 | 0.064 | 0.023 | 0.024 | 3.07 | 0.68 | 0.20 | 0.02 | 0.15 | 0.12 | 0.002 | 0.031 | 0.010 |

| | | | | | Magnetic | | | Core Loss at | |
|---|---|---|---|---|---|---|---|---|---|
| | | | | Volume | Permeability at | | | 1.7 T 60 Hz, | |
| | | Cr:(P + Sb/4) | | resistivity, | H = 796 A/m | | | w/lb | |
| Method | Heat | ratio | γ_{1150° C.} | μΩ-cm | Mean | Max | Worst | Mean | Worst |
| Prior Art | O | 81 | 45% | 50 | 1907 | 1916 | 1899 | 1.19 | 1.22 |
| Prior Art | P | 80 | 36% | 51 | 1911 | 1921 | 1900 | 1.25 | 1.14 |
| Prior Art | Q | 72 | 45% | 50 | 1916 | 1926 | 1905 | 1.23 | 1.15 |
| Example | R | 48 | 42% | 50 | 1913 | 1922 | 1903 | 1.21 | 1.15 |
| Example | S | 48 | 43% | 50 | 1915 | 1921 | 1906 | 1.21 | 1.14 |
| Example | T | 45 | 46% | 50 | 1913 | 1916 | 1910 | 1.20 | 1.18 |
| Example | U | 30 | 43% | 51 | 1918 | 1922 | 1913 | 1.18 | 1.14 |
| Example | V | 29 | 41% | 51 | 1916 | 1916 | 1915 | 1.15 | 1.15 |

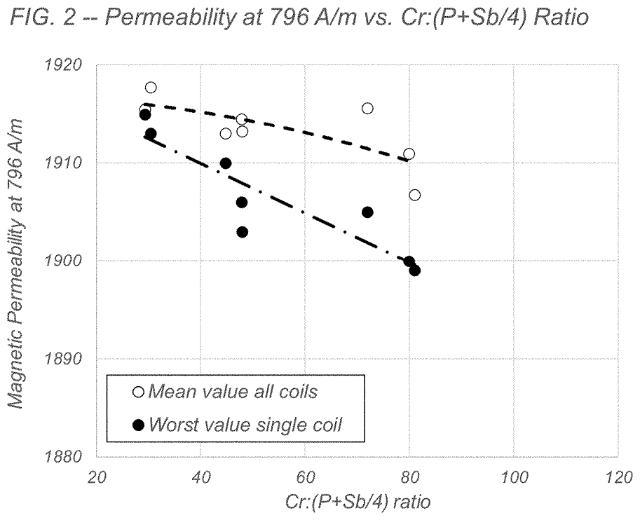

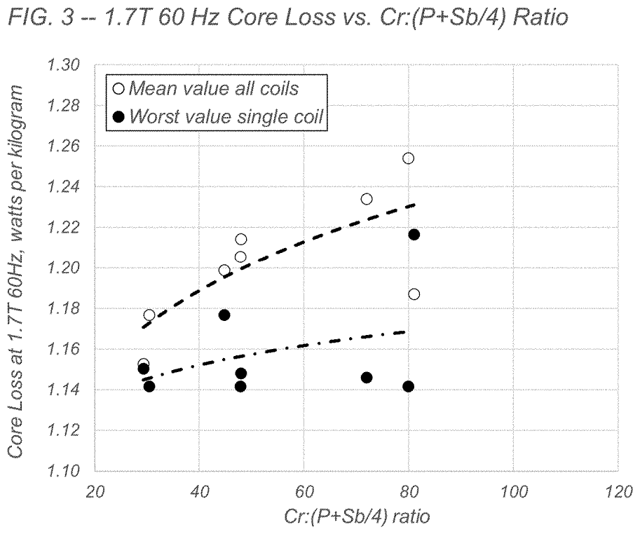

All heats were continuously cast into slab and processed through hot rolling, strip annealing and rapid cooling following the manner cited in Example 1. The annealed-and-rapidly-cooled strip was cold rolled to a final thickness of 0.27 mm and decarburization annealed in a process wherein the strip was heated at a rate in excess of 500° C. per second to a temperature of 740° C. and then heated in a conventional manner to a soak temperature of 815° C. in a humidified hydrogen-nitrogen atmosphere having a H₂O/H₂ ratio of nominally 0.35-0.45 for a time sufficient to reduce the carbon level in the steel to 0.002% or less, about 120 seconds. The decarburized strip was provided with MgO annealing separator coating containing 5% TiO₂ and other additives, dried and wound into a coil. The coil was final annealed by heating in a 25% nitrogen 75% hydrogen atmosphere to a soak temperature of nominally 1200° C. whereupon the steel was held for a time of at least 15 hours in 100% dry hydrogen to effect secondary grain growth and purification. Afterwards, the coils were unwound and scrubbed to remove excess MgO, coated with a secondary coating, thermally flattened at a temperature of 850° C. and laser scribed after heating flattening was completed. After processing was completed, test samples were cut from the head and tail ends of each coil and tested for magnetic permeability at 796 A/m and core loss at 1.7T 60 Hz using the Epstein test method of ASTM A343. The heat-average and worst-test values for magnetic permeability and core loss versus Cr:[P+(0.25Sb)] ratio is shown in FIGS. 2 and 3, respectively.

As FIGS. 2 and 3 illustrate, steels having a chromium content of 0.65% to 0.70% provided both higher and more consistent magnetic permeability and lower and more consistent core loss when the Cr:[P+(0.25Sb)] ratio was within the range of the present method. The appearance and technical attributes of the forsterite coating formed on the product were excellent.

### Example 4

A series of industrial heats containing 0.89-1.07% chromium was melted having compositions exemplary of the prior art and of the present invention as shown in Table 5. Heats W through AB are compositions of a steel of the prior art, having a normal residual level of 0.008%-0.009% phosphorus thereby having a Cr:[P+(0.25Sb)] ratio of 80:1 or more. Heats AC through AG are compositions of the present high permeability grain oriented steels, containing as much as 0.040% phosphorus such that a Cr:[P+(0.25Sb)] ratio of 35:1 or lower was provided.

TABLE 5

| | | Chemistry in Weight Percent | | | | | | | | | | | | |
|---|---|---|---|---|---|---|---|---|---|---|---|---|---|---|
| Method | Heat | C | Mn | P | S | Si | Cr | Ni | Mo | Cu | Sn | Ti | Al | N |
| Prior Art | W | 0.055 | 0.076 | 0.008 | 0.028 | 3.05 | 0.91 | 0.09 | 0.02 | 0.15 | 0.12 | 0.002 | 0.034 | 0.010 |
| Prior Art | X | 0.056 | 0.073 | 0.008 | 0.026 | 3.04 | 0.91 | 0.09 | 0.02 | 0.15 | 0.12 | 0.002 | 0.032 | 0.010 |
| Prior Art | Y | 0.055 | 0.074 | 0.008 | 0.026 | 3.08 | 0.89 | 0.09 | 0.02 | 0.15 | 0.11 | 0.002 | 0.032 | 0.010 |
| Prior Art | Z | 0.055 | 0.075 | 0.009 | 0.026 | 3.05 | 0.91 | 0.09 | 0.02 | 0.15 | 0.14 | 0.002 | 0.033 | 0.010 |
| Prior Art | AA | 0.052 | 0.077 | 0.009 | 0.024 | 3.04 | 0.91 | 0.10 | 0.02 | 0.15 | 0.12 | 0.003 | 0.034 | 0.011 |
| Prior Art | AB | 0.055 | 0.073 | 0.009 | 0.026 | 3.04 | 0.89 | 0.09 | 0.02 | 0.15 | 0.12 | 0.002 | 0.034 | 0.010 |
| Example | AC | 0.056 | 0.073 | 0.012 | 0.026 | 3.07 | 0.91 | 0.09 | 0.02 | 0.15 | 0.12 | 0.002 | 0.034 | 0.010 |
| Example | AD | 0.051 | 0.059 | 0.028 | 0.026 | 2.99 | 0.96 | 0.09 | 0.02 | 0.15 | 0.13 | 0.002 | 0.030 | 0.010 |
| Example | AE | 0.050 | 0.058 | 0.035 | 0.026 | 3.00 | 1.07 | 0.10 | 0.01 | 0.15 | 0.13 | 0.003 | 0.026 | 0.010 |
| Example | AF | 0.049 | 0.060 | 0.037 | 0.026 | 3.01 | 1.07 | 0.09 | 0.01 | 0.15 | 0.13 | 0.003 | 0.026 | 0.010 |
| Example | AG | 0.048 | 0.059 | 0.038 | 0.025 | 3.03 | 1.07 | 0.09 | 0.01 | 0.15 | 0.13 | 0.003 | 0.026 | 0.010 |
| Example | AH | 0.047 | 0.061 | 0.033 | 0.025 | 3.01 | 0.90 | 0.20 | 0.02 | 0.18 | 0.12 | 0.002 | 0.029 | 0.010 |
| Example | AK | 0.050 | 0.058 | 0.039 | 0.028 | 3.04 | 1.06 | 0.10 | 0.02 | 0.16 | 0.13 | 0.002 | 0.029 | 0.011 |

| | | | | | Magnetic | | Core Loss at | |
|---|---|---|---|---|---|---|---|---|
| | | | | Volume | Permeability at | | 1.7 T 60 Hz, | |
| | | Cr:(P + Sb/4) | | resistivity, | H = 796 A/m | | w/kg | |
| Method | Heat | ratio | γ_{1150° C.} | μΩ-cm | Mean | Worst | Mean | Worst |
| Prior Art | W | 114 | 47% | 51.8 | 1836 | 1694 | 1.30 | 1.96 |
| Prior Art | X | 114 | 49% | 51.6 | 1851 | 1727 | 1.23 | 1.81 |
| Prior Art | Y | 111 | 46% | 51.9 | 1809 | 1624 | 1.41 | 2.30 |
| Prior Art | Z | 101 | 47% | 51.9 | 1854 | 1796 | 1.20 | 1.40 |
| Prior Art | AA | 101 | 45% | 51.7 | 1814 | 1629 | 1.45 | 2.40 |
| Prior Art | AB | 99 | 48% | 51.4 | 1851 | 1804 | 1.26 | 1.47 |
| Example | AC | 76 | 46% | 52.0 | 1870 | 1851 | 1.14 | 1.21 |
| Example | AD | 34 | 45% | 51.6 | 1886 | 1865 | 1.10 | 1.16 |
| Example | AE | 31 | 44% | 52.5 | 1890 | 1864 | 1.06 | 1.14 |
| Example | AF | 29 | 42% | 52.7 | 1902 | 1861 | 1.05 | 1.06 |
| Example | AG | 28 | 40% | 52.9 | 1904 | 1891 | 1.05 | 1.09 |
| Example | AH | 27 | 42% | 51.8 | 1903 | 1885 | 1.07 | 1.13 |
| Example | AK | 27 | 41% | 53.1 | 1904 | 1898 | 1.05 | 1.06 |

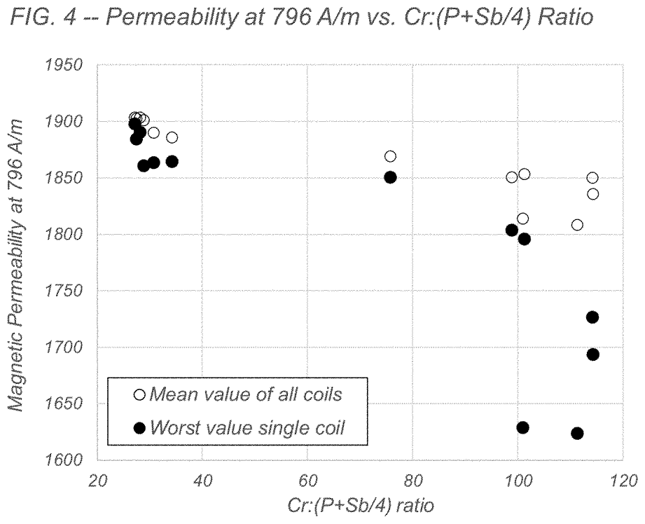

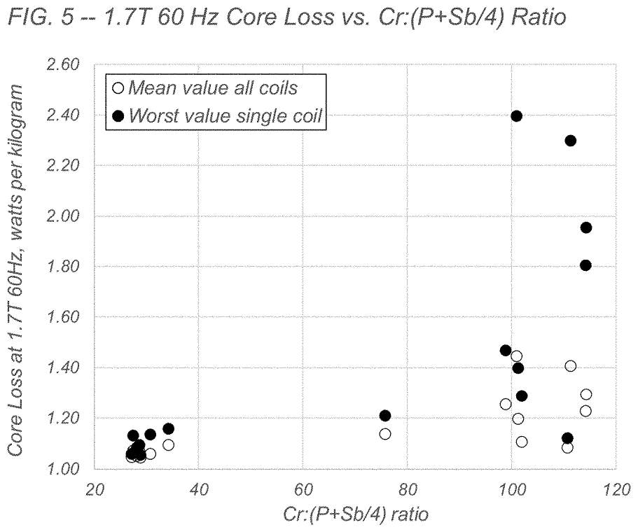

All heats were continuously cast into slabs and processed in the manner cited in Example 3 with the exception that the steel was cold rolled to a final thickness of 0.23 mm. After processing was completed, test samples were cut from the head and tail ends of each coil and tested for magnetic permeability at 796 A/m and core loss at 1.7T 60 Hz using the Epstein test method of ASTM A343. The heat-average and worst-test values for magnetic permeability and core loss versus Cr:[P+(0.25Sb)] ratio are shown in FIGS. 4 and 5, respectively.

As FIG. 4 illustrates, the present method provided significantly improved product consistency and superior development of the magnetic permeability in steels having a chromium content of from 0.90% to 1.1%. The core loss was improved owing to high volume resistivity provided by the high chromium content and high degree of grain orientation achieved using the present method. Moreover, the physical appearance and technical attributes of the forsterite coating formed on the product was found to be excellent.

What is claimed is:

1. A high permeability grain oriented electrical steel hot band comprising, by weight, 2.5% to 4.5% silicon, 0.02% to 0.08% carbon, 0.01% to 0.05% aluminum, 0.005% to 0.012% nitrogen, 0.005% to 0.050% sulfur or selenium, 0.02% to 0.20% manganese, 0.05% to 0.25% tin, 0.05% to 1% copper, 0.5% to 2.0% chromium, up to 0.10% phosphorus and up to 0.20% antimony with the balance being essentially iron and residual elements; wherein the ratio of weight percent of chromium to [weight percentage of phosphorus+0.25 times weight percentage of antimony] is less than 80:1 and wherein said band has a thickness of about 1.5 to about 4 mm, a volume resistivity of 50 μΩ-cm or greater, and an austenite volume fraction (γ1150° C.) of at least about 20%.

2. The high permeability grain oriented electrical steel hot band of claim 1 comprising, by weight, 0.6% to 1.8% chromium.

3. The high permeability grain oriented electrical steel hot band of claim 1 comprising, by weight, 0.7% to 1.7% chromium.

4. The high permeability grain oriented electrical steel hot band of claim 1 comprising, by weight, 0.015% to 0.065% phosphorus.

5. The high permeability grain oriented electrical steel hot band of claim 1 comprising, by weight, 0.020% to 0.045% phosphorus.

6. The high permeability grain oriented electrical steel hot band of claim 1 wherein the ratio of weight percent of chromium to [weight percentage of phosphorus+0.25 times weight percentage of antimony] is less than 50:1.

7. The high permeability grain oriented electrical steel hot band of claim 1 wherein the ratio of weight percent of chromium to [weight percentage of phosphorus+0.25 times weight percentage of antimony] is less than 30:1.

8. The high permeability grain oriented electrical steel hot band of claim 1 comprising no intentionally added antimony and wherein the ratio of weight percent of chromium to weight percentage of phosphorus is less than 80:1.

9. The high permeability grain oriented electrical steel hot band of claim 1 comprising no intentionally added antimony and wherein the ratio of weight percent of chromium to weight percentage of phosphorus is less than 50:1.

10. The high permeability grain oriented electrical steel hot band of claim 1 comprising no intentionally added antimony and wherein the ratio of weight percent of chromium to weight percentage of phosphorus is less than 30:1.

11. A method for producing a high permeability grain oriented electrical steel comprising the steps of:
providing the hot band of claim 1;
annealing said band to form a strip prior to final cold rolling at a temperature of from 1100° C. to 1200° C. for a time of from 10 seconds to 10 minutes following by rapid cooling of the annealed strip at a rate greater than 50° C. per second;
cold rolling the cooled and annealed strip in one or more stages such that the cold rolled strip prior to decarburization annealing is provided with a cold reduction of at least 80%;
decarburization annealing the cold rolled strip;
coating at least one surface of the decarburization annealed strip with an annealing separator coating;
and final annealing the coated strip.

12. The method of claim 11 wherein the rapid cooling of the annealed strip is performed at a rate of greater than 60° C. per second.

13. The method of claim 11 wherein the rapid cooling of the annealed strip is performed at a rate of greater than 70° C. per second.
